(19) United States
(12) Patent Application Publication
(10) Pub. No.: US 2007/0116125 A1
(43) Pub. Date: May 24, 2007

(54) VIDEO ENCODING/DECODING METHOD AND APPARATUS

(76) Inventors: Naofumi Wada, Yokohama-shi (JP); Tomoya Kodama, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/561,079

(22) Filed: Nov. 17, 2006

(30) Foreign Application Priority Data
Nov. 24, 2005 (JP) 2005-338775

(51) Int. Cl. H04N 11/02

(52) U.S. Cl. 375/240.16

(57) ABSTRACT

A video encoding method includes subjecting an input video image to motion compensated temporal filtering using a motion compensated temporal filter to produce a low-pass filtered image, quantizing a transform coefficient of the low-pass filtered image, encoding a quantized transform coefficient, calculating a weight to be given to a low-pass filter coefficient of a low-pass filter of the motion compensated temporal filter according to coarseness of quantization and a magnitude of a motion compensated error, and controlling a high band stopping characteristic of the low-pass filter according to the low-pass filter coefficient weighted by the weight, wherein the controlling controls the high band stopping characteristic of the low-pass filter to provide a positive correlation with respect to the quantization parameter and provide a negative correlation with respect to the magnitude of the motion compensated error.

### CROSS-REFERENCE TO RELATED APPLICATIONS

This application is based upon and claims the benefit of priority from prior Japanese Patent Application No. 2005-338775, field Nov. 24, 2005, the entire contents of which are incorporated herein by reference.

### BACKGROUND OF THE INVENTION

1. Field of the Invention

The invention relates to a video encoding/decoding method using a temporal filter with motion compensation and an apparatus for the same.

2. Description of the Related Art

In recent years, a video encoding/decoding technique using a motion compensated temporal filtering (MCTF) attracts attention. MCTF performs a motion compensated temporal subband decomposition to divide an input video image into a high frequency component (prediction error frame) and a low frequency component (average frame) with respect to a temporal direction. The decoding does an inverse operation from the encoding, that is, synthesizes the high frequency component and the low frequency component by the temporal wavelet synthesis to reconstruct an output video image. The video encoding/decoding using MCTF is useful in terms of the encoding efficiency as well as providing temporal scalability by the above operation.

In Joint Video Team (JVT) of ISO/IEC MPEG & ITU-T VCEG, 14th Meeting: HongKong, CN, Jan. 17-21 2005, “JVT-N020d1” teaches a technique of determining a weight of an equation for calculating a low-pass frame, using a product of values concerning “a ratio of corresponding pixels” and “similarity of frames” to a 4*4 pixel block including pixels to be filtered with a low-pass filter, in order to improve the entire encoding efficiency by changing a characteristic of a low-pass filter.

When motion compensation is performed on the basis of blocks like a conventional MPEG-2, H.264/AVC, etc., a motion vector is assigned to each block. Therefore, when an inverse motion vector is obtained, mismatching between corresponding pixels may occur between a high-pass filter and a low-pass filter. Because the mismatch between corresponding pixels causes deterioration of the encoding efficiency, a weighting is performed so that the low-pass filter coefficient decreases as the mismatched pixels increase in a 4*4 pixel block filtered by a low-pass filter.

There are a technique to determine a weight to be given to the low-pass filter coefficient using only motion compensated residual power of high-pass frame as disclosed by N. Mehrseresht and D. Taubman, “Adaptively Weighted Update Steps In Motion Compensated Lifting Based Scalable Video Compression”, IEEE International Conference on Image Processing 2003, vol. 3, pp 771-774, September, 2003, and a technique to determine a weight to be given to a low-pass filter coefficient according to an activity of a low-pass frame as well as a magnitude of motion compensated error as disclosed by D. Maestroni, M. Tagliasacchi and S. Tubaro, “In-band Adaptive Update Step Based On Local Content Activity”, Visual Communications and Image Processing 2005, July, 2005.

However, any of the above conventional techniques does not control a high band stopping characteristic of the low-pass filter based on coarseness of quantization.

As described above, there is a problem a high band stopping characteristic of a low-pass filter in a motion compensated temporal filter cannot be selected according to coarseness of quantization by a conventional technology. There is a problem a threshold value in the control function for controlling a low-pass filter coefficient concerning a motion compensated error and a motion vector cannot be adaptively selected every plural frames/fields or every single frame/field.

### BRIEF SUMMARY OF THE INVENTION

An aspect of the present invention provides a video encoding method comprising: subjecting an input video image to motion compensated temporal filtering using a motion compensated temporal filter including a low-pass filter to produce a low-pass filtered image; quantizing a transform coefficient of the low-pass filtered image using a quantization parameter; encoding a quantized transform coefficient; calculating a weight to be given to a low-pass filter coefficient of the low-pass filter according to the quantization parameter and a magnitude of a motion compensated error occurring due to motion compensation in the motion compensated temporal filtering; and controlling a high band stopping characteristic of the low-pass filter according to the low-pass filter coefficient weighted by the weight, wherein the controlling controls the high band stopping characteristic of the low-pass filter to provide a positive correlation with respect to the quantization parameter and provide a negative correlation with respect to the magnitude of the motion compensated error.

### BRIEF DESCRIPTION OF THE SEVERAL VIEWS OF THE DRAWINGS

FIG. 1 is a block diagram of a video encoding apparatus concerning the first embodiment.

FIG. 2 is a process flow of a video encoding apparatus concerning the first embodiment.

FIG. 3 shows a table used for determining the threshold value TH2 based on the quantization parameter QP.

FIG. 4 is a diagram showing a data structure of a sequence header concerning the first embodiment.

FIG. 5 is a diagram showing a data structure of a picture header concerning the first embodiment.

FIG. 6 is a diagram showing a data structure of a slice header concerning the first embodiment.

FIG. 7 is a block diagram of a video encoding apparatus concerning the second embodiment.

FIG. 8 is a block diagram of a video decoding apparatus concerning the third embodiment.

FIG. 9 is a process flow of the video decoding apparatus concerning the third embodiment.

FIG. 10 is a block diagram of a video decoding apparatus concerning the fourth embodiment.

FIG. 11 is a diagram representing a temporal direction subband decomposition using a motion compensated temporal filter.

FIG. 12 is a diagram for explaining encoding and decoding done by a lifting operation in a motion compensated temporal filter.

FIG. 13 is a diagram indicating an effect of a motion compensated temporal filter for an image including a noise.

FIG. 14 is a diagram showing a change of PSNR and bit rate with respect to change of weight applied to a low-pass filter coefficient.

### DETAILED DESCRIPTION OF THE INVENTION

The embodiment of the present invention adopts a video encoding/decoding technique using a motion compensated temporal filtering (MCTF). Before describing the embodiment, the video encoding/decoding method will be described in conjunction with FIG. 11.

Video encoding using MCTF encodes an input video image in units of a group of the given number of frames (GOP: Group of Picture). A concept of the temporal direction subband decomposition when GOP is 8 frames is shown in FIG. 11.

Eight frames f1 to f8 in GOP are divided into high-pass frames H of high-frequency components and low-pass frames L of low-frequency components by the first stage temporal subband decomposition. The temporal subband decomposition further is done by only the low-pass frame of level 1, so that the frames can be divided into high-pass frames LH and low-pass frames LL of level 2. As thus described the frames are divided hierarchically, and they are finally divided into seven high-pass frames H, LH, LLH and one low-pass frame LLL. The divided high-pass frames and low-pass frame are transformed, quantized and entropy-coded every frame, and multiplexed with a bit stream.

Receiving the bit stream, the decoding apparatus entropy-decodes, dequantizes and inverse-transforms the bit stream to reconstruct one low-pass frame and seven high-pass frames (each including quantization error). An output image is produced by combining these frames while tracing a hierarchy from the level 3 to the level 1 shown in FIG. 11.

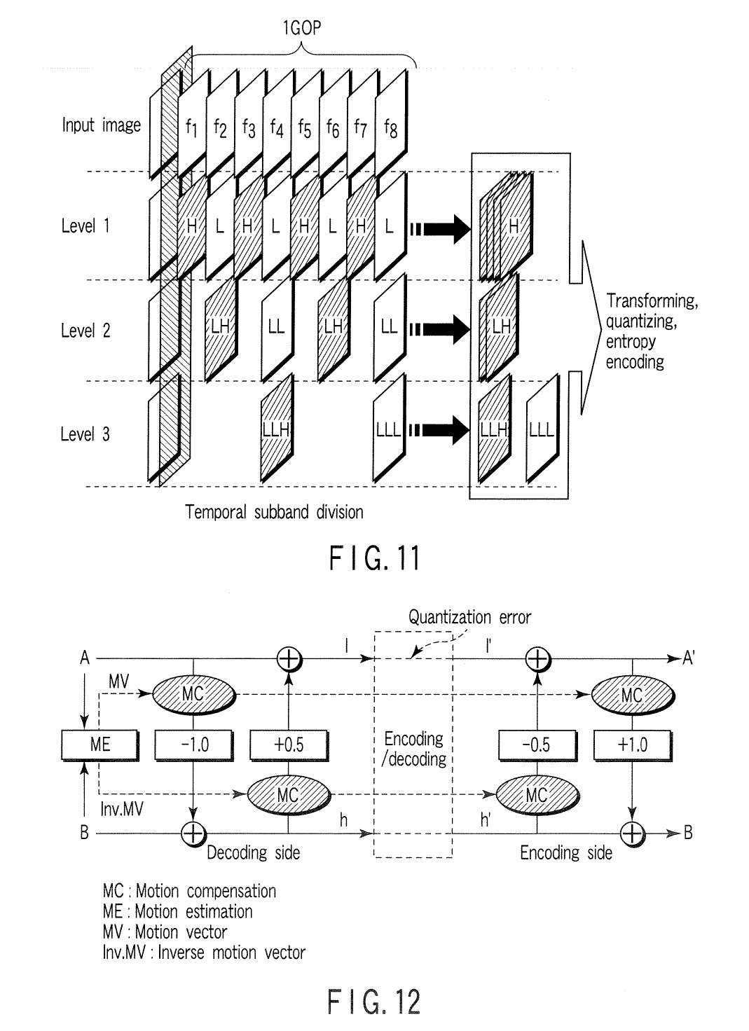

A method of dividing into the high-pass frames and low-pass frame and a method of producing a composite output image will be described in details referring to FIG. 12. In FIG. 12, a Haar filter is used as the motion compensated temporal filter applied to frames A and B. A filter process is done by a lifting operation to apply the high-pass filter and low-pass filter step by step in this embodiment. FIG. 12 is a diagram for explaining the lifting operation.

In the encoding apparatus, a motion vector between the frames A and B is detected by motion estimation according to the following equation (1):
h(x,y)=B(x,y)−1.0×Â(x,y) (1)

A frame Â is produced by motion-compensating the high-pass frame h based on a inverse motion vector obtained by reversing a sign of the motion vector. Thereafter, the low-pass frame 1 is calculated by the following equation (2).
l(x,y)=A(x,y)+0.5×ĥ(x,y) (2)

Thinking about the high-pass frame h and low-pass frame l without regard to motion compensation, the high-pass frame h represents a prediction error between the frames A and B, and the low-pass frame 1 represents an average of the frames A and B. The decoding apparatus can obtain an output image by inverse operation of the encoding apparatus. In other words, the decoding apparatus reconstructs the frames A′ and B′ using the high-pass frame h′ and low-pass frame 1′ (including quantization errors in the frames h and 1) according to the following equations (3) and (4):.
A′(x,y)=l′(x,y)−0.5×h′(x,y) (3)
B′(x,y)=h′(x,y)+1.0×Â′(x,y) (4)

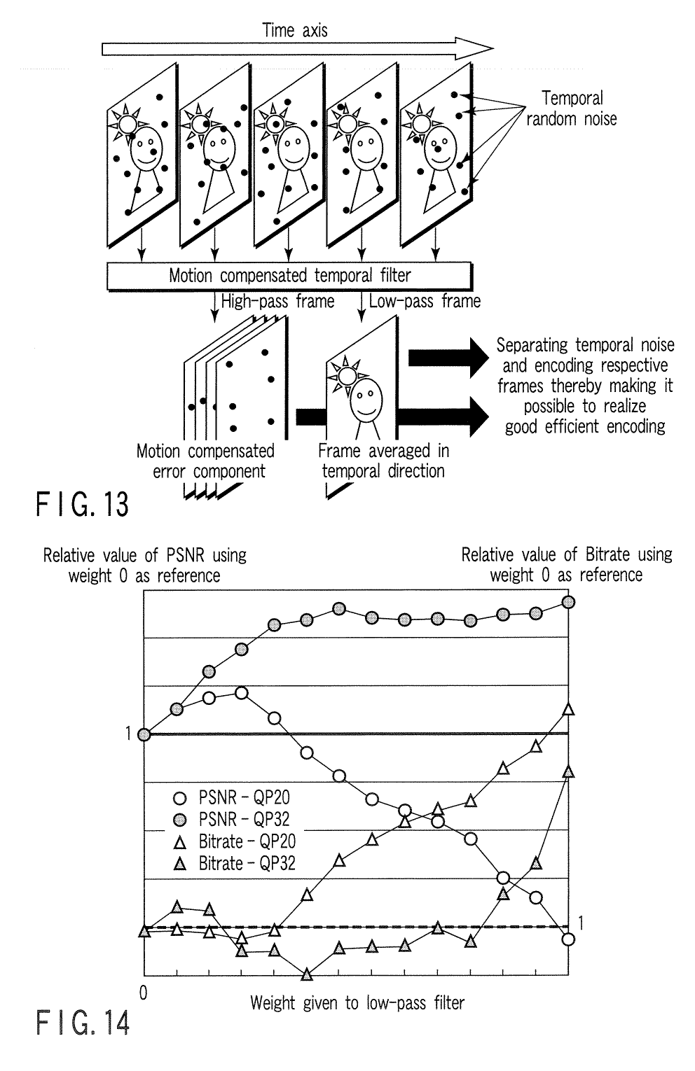

As discussed above, it is different from MPEG-2 or H.264/AVC which is a conventional encoding system that the video encoding using MCTF generates the low-pass frame l by averaging a plurality of frames. In the case of a sequence including temporal random noises (e.g. film grain noises of a movie) as shown in FIG. 13, the high encoding efficiency can be obtained by encoding individually the high-pass frame generated by extracting the temporal noises as a predictive residue component and the low-pass frame generated by averaging a plurality of frames to reduce temporal noises.

It is reported that the video encoding using the conventional MCTF is improved in entire encoding efficiency by changing the characteristic of the low-pass filter. In the case of using a low-pass filter, for example, a Haar filter, the equation (2) can be changed to the following equation (5) using the weight W (0≦W≦1) given to the low-pass filter coefficient.
l(x,y)=A(x,y)+W×0.5×ĥ(x,y) (5)

FIG. 14 shows a relation of bit rate and PSNR when the weight W given to the low-pass filter coefficient is changed according to a magnitude of motion compensated error in the case that the quantization parameters QP representing coarseness of quantization are assumed to be 20 and 32. In other words, FIG. 14 shows a graph plotting the relations between bit-rate and PSNR using as a reference point that the weight W is 0. It can be seen from FIG. 14 that the optimal point differs by the difference in the quantization parameters QP, and there is a positive correlation between the quantization parameter QP and the optimum weight W for the low-pass filter coefficient.

There will now be explained an embodiment of the present invention referring to accompany drawings hereinafter.

### FIRST EMBODIMENT

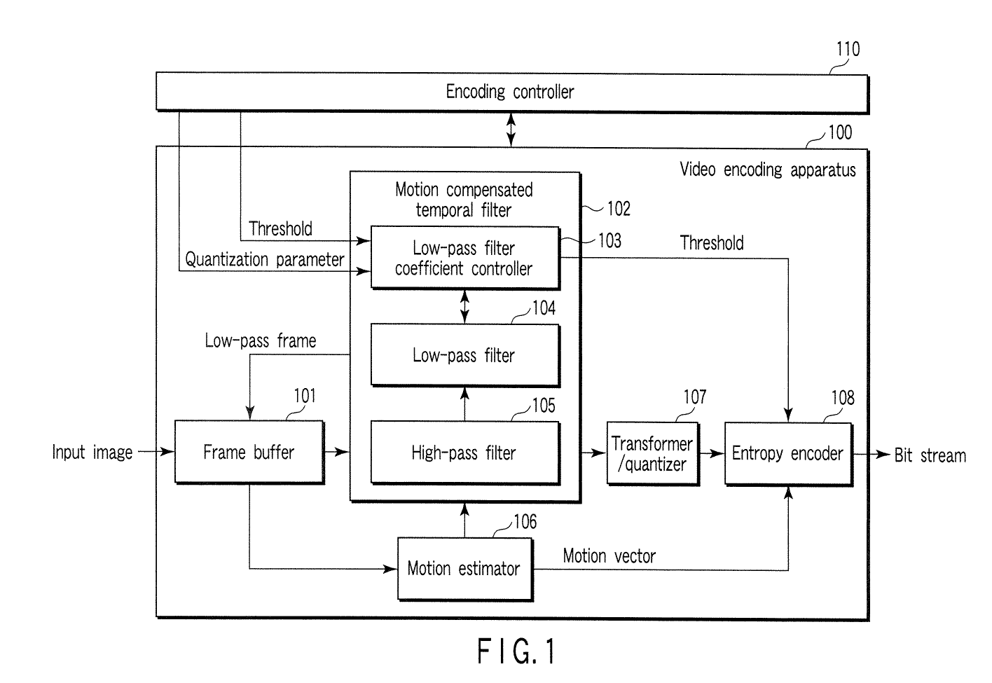

The video encoding apparatus 100 shown in FIG. 1 comprises a frame buffer 101, a motion compensated temporal filter 102, a low-pass filter coefficient controller 103, a low-pass filter 104, a high-pass filter 105, a motion estimator 106, a transformer/quantizer 107, an entropy encoder 108, and an encoding controller 110 for controlling them. This encoding controller 110 performs quantization parameter control, etc. on the high-pass frame and low-pass frame, and controls the entire encoding.

The frame buffer 101 stores frames fetched from an input video image for one GOP. Alternatively, when the low-pass frame generated with the motion compensated temporal filter 102 is divided into a high-frequency component and low-frequency component in temporal direction further, the frame buffer 101 stores the generated low-pass frame.

The motion estimator 106 performs motion estimation to generate a prediction error signal with the high-pass filter 105 in the motion compensated temporal filter 102, using the frame and reference image stored in the frame buffer 101, and detects a motion vector. The motion compensated temporal filter 102 comprises a low-pass filter coefficient controller 103, a low-pass filter 104, and a high-pass filter 105. The motion compensated temporal filter 102 subjects the frame acquired from the frame buffer 101 to motion compensated temporal filtering using the motion vector detected with the motion estimator 106 to produce a high-pass frame and low-pass frame. The generated high-pass frame is sent to the transformer/quantizer 107. The low-pass frame is send to the frame buffer 101 to be subjected to the motion compensated temporal filtering and temporal decomposition again, or to the transformer/quantizer 107 when it is not subjected to the temporal decomposition further.

The high-pass filter 105 performs motion compensation on the frame acquired from the frame buffer 101 using the motion vector detected with the motion estimator 106, and generates a high-pass frame corresponding to a prediction error signal by filtering the motion compensated frame using a given high-pass filter coefficient. The low-pass filter 104 performs motion compensation on the frame using the inverse motion vector, and generates a low-pass frame using the low-pass filter coefficient determined with the low-pass filter coefficient controller 103.

The low-pass filter coefficient controller 103 acquires a quantization parameter or a threshold value from the encoding controller 110, as well as the motion compensated error and motion vector, and controls the high band stopping characteristic of the low-pass filter based on them. Further it outputs a threshold value to the entropy encoder 108 every plural frames/fields or every frame/field.

The transformer/quantizer 107 subjects the frame acquired from the motion compensated temporal filter 102 to transform, for example, discrete cosine transform, quantizes the transform coefficient based on a determined quantization parameter, and outputs the quantized transform coefficient to the entropy encoder 108. The entropy encoder 108 encodes the quantized transform coefficient acquired from the transformer/quantizer 107, and information such as the motion vector detected with the motion estimator 106, a prediction mode, the quantization parameter, a threshold value, and multiplexes them with a bit stream. The information to be multiplexed with the bit stream needs not be always entropy-coded.

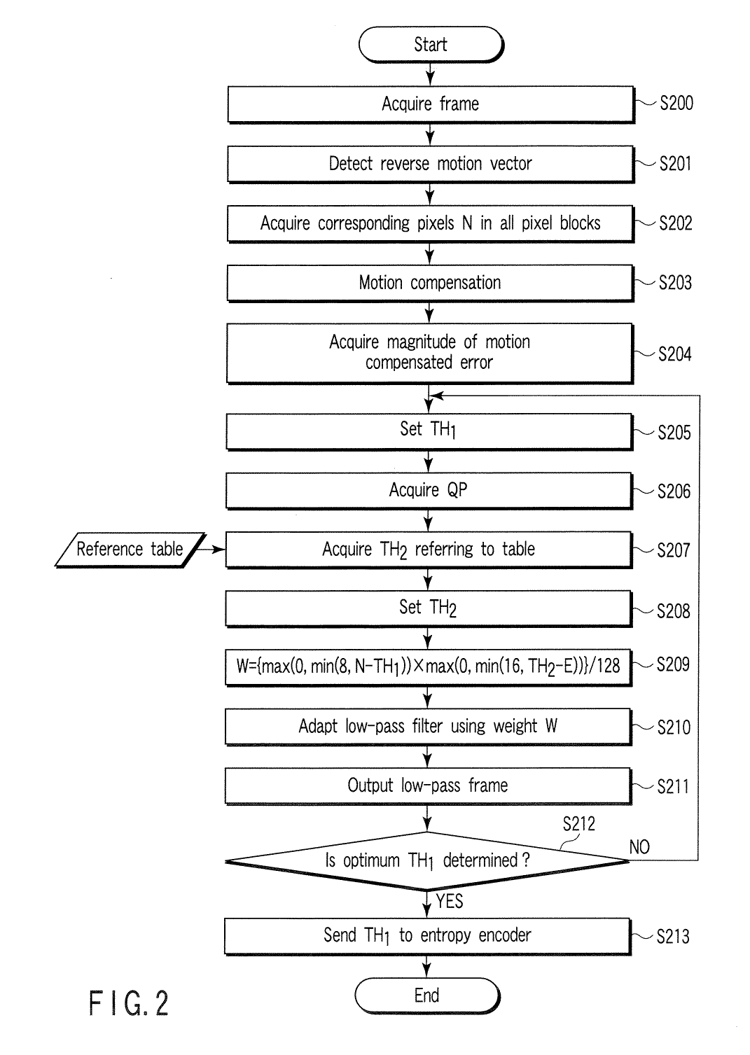

In the video encoding apparatus 100, the process executed by the low-pass filter coefficient controller 103 and low-pass filter unit 104 related to the present embodiment will be explained referring to a flow chart of FIG. 2.

There will be described the process of determining the weight W given to the low-pass filter coefficient for each 4*4 pixel block and carrying out the temporal low-pass filtering according to the weight W. The weight W given to the low-pass filter coefficient is calculated by the following equation (6) and (7):

$$\begin{matrix} W = \{ max ( 0 , min ( 8 , N - {TH}_{1} ) ) \times max ( 0 , min ( 16 , {TH}_{2} - E ) ) \} / 128 & ( 6 ) \\ E = ( 128 + {\sum }_{x , y ∈ b}^{} {h ( x , y )}^{2} ) / 256 & ( 7 )\end{matrix}$$

max(0,min (8,N-TH1)) of the equation (6) represents the weight about “a ratio of corresponding pixels to the block” and takes 0 to 8 values. N represents “the number of corresponding pixels” in the 4*4 pixel block, and is an integer value in the range of 0≦N≦16. max (0,min(16, TH2−E)) of the equation (6) represents a weight about “similarity of frame” and takes 0 to 16 values. The “similarity of frame” indicates how correctly the motion estimation can express movement by using the power of motion compensated error, and is determined based on a value of E. E is expressed by the equation (7), and determined based on the sum of motion compensated error powers of pixels in the pixel block b (16 pixels because of use of the 4*4 pixel block in the embodiment) in the high-pass frame.

The motion compensated error increases in the cases that accuracy of motion estimation is not enough. Therefore, when the low-pass filter based on motion compensated error is used, the encoding efficiency of low-pass frame is degraded remarkably. When the pixel block has the large power of motion compensated error, the weight for the low-pass filter is controlled so that the low-pass filter coefficient decreases.

At first, when both the frame A that applies the low-pass filter and the high-pass frame h to be referred to are input, the low-pass filtering process is started (step S200). The frame A is an input image or a low-pass frame generated by the motion compensated temporal filter 102.

The sign of the motion vector detected with the motion estimator 106 is inversed, and an inverse motion vector for the low-pass filter is acquired by assigning the inverse motion vector to each block of the frame A (step S201). The number of corresponding pixels N is decided on every block in the frame A based on the inverse motion vector acquired in step S201 (step S202). Motion compensation is subjected to the high-pass frame h by using this inverse motion vector (step S203).

The magnitude E of the motion compensated error in the motion compensated high-pass frame hcorresponding to each block of the frame A is calculated based on the equation (7) (step S204). The threshold value TH1 concerning the number of corresponding pixels N is set at the equation (6) (step S205). The threshold value TH1 is an integer value in the range of 0 to 15. For example, 0 may be set as an initial value or 8 may be set similarly to the conventional technique.

The quantization parameter QP is acquired from the encoding controller 110 (step S206). The quantization parameter QP represents coarseness of quantization, and takes a value from 0 to 51 like the conventional encoding system H.264/AVC. The acquired QP may be a quantizatioin parameter acquired by some prediction. Alternatively, it may be a quantization parameter used in quantizing the high-pass frame h to be referred.

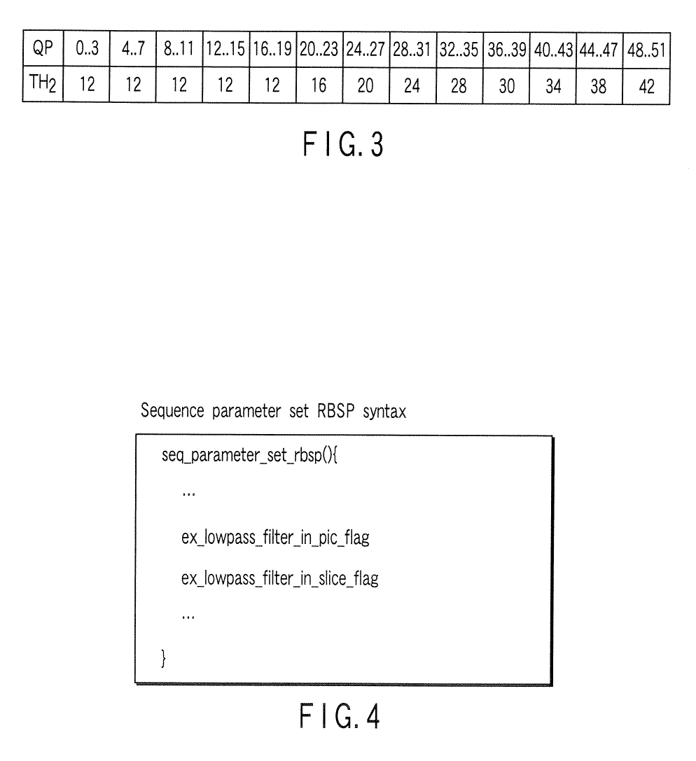

The threshold value TH2 in the equation (6) concerning E is obtained based on QP acquired in step S206 and referring to a predetermined table (step S207). An example of a lookup table used in the embodiment is shown in FIG. 3. In the table of FIG. 3, for example, “0 . . . 3” indicates QP is a value from 0 to 3 (0, 1, 2, 3). The threshold value TH2 is decided by QP, and the table of FIG. 3 shows that TH2 corresponding to QP: “0 . . . 3” is 12.

The threshold value TH2 acquired as described above is set to the equation (6) (step S208). The weight W to be given to the low-pass filter coefficient is calculated according to the equation (6) determined by the threshold values TH1 and TH2 set in steps S205 and S208 (step S209). When the weight W is calculated for all blocks of the frame A in step S209, the low-pass filtering is executed for all pixels of the frame A (step S210), whereby a low-pass frame is generated (step S211).

It is evaluated in step S212 whether the low-pass frame output in step S211 is optimum. The evaluation method executes the process of steps from S205 to S211 about all threshold values TH1 (integer of 0 to 15), evaluates the threshold values by using a cost function calculated from the number of encoded bits of the low-pass frame and a distortion by the following equation (8), and selects the optimum one of the threshold values TH1.
Cost=D+λ×R (8)
λ=0.85×2^{(QP-}12)/3
where D represents a distortion and R represents the number of encoded bits. The threshold value TH1 corresponding to the minimum cost is selected based on the encoding cost calculated in this way. If the optimum threshold value TH1 is determined, the threshold value TH1 is sent to the entropy encoder 108 (step S213).

There will be explained a method of encoding the threshold value TH1. FIGS. 4 to 6 show syntax information in encoding the threshold value determined every image, for example, every frame or every field and multiplexing them to a bitstream according to this embodiment. ex_low-pass_filter_in_pic_flag shown in a sequence header of FIG. 4 is a flag showing whether the threshold value TH1 should be encoded every frame. If this flag is 1, the threshold value TH1 can be changed every frame.

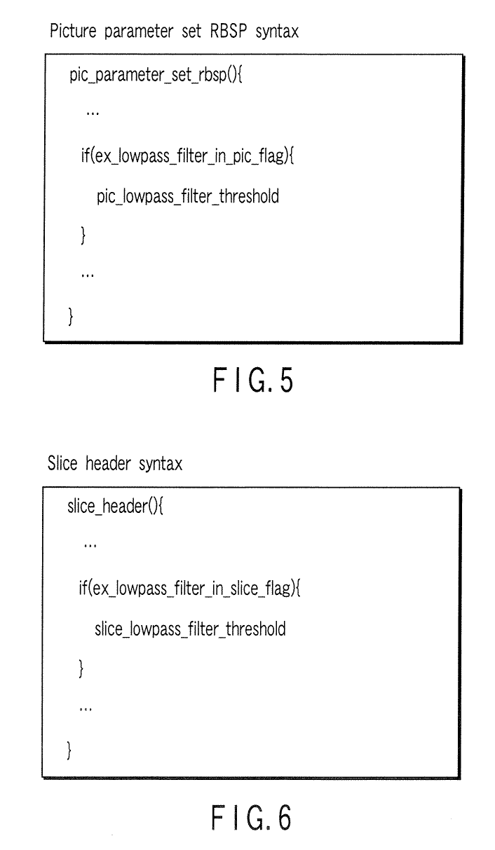

ex_low-pass_filter_in_slice_flag is a flag showing whether the threshold value TH1 is encoded every field. If this flag is 1, the threshold value TH1 can be changed every field. If ex_low-pass_filter_in_pic_flag shown in FIG. 4 is 1, pic_low-pass_filter_threshold is encoded in a picture header of FIG. 5. Similarly, if ex_low-pass_filter_in_{—l slice}_flag shown in FIG. 4 is 1, slice_low-pass_filter_threshold is encoded in a slice header of FIG. 6.

The process of steps S200 to S213 may use a threshold value TH1 (for example, 8 of a general technique) in step S205 without doing an optimization process of step S212. In this case, the threshold value needs not be sent to the entropy encoder 108 in step S213. The threshold value TH2 may be determined by performing the optimization process based on the threshold value TH2 in step S212 without doing the process of steps S206 and S207. In this case, the threshold value TH2 is sent to the entropy encoder 108 in step S213.

According to a video encoding apparatus concerning the first embodiment, it becomes possible to improve the encoding efficiency by selecting a high band stopping characteristic of a low-pass filter every frame or every field based on the threshold value TH2 determined by the threshold value TH1 and a quantization parameter.

### SECOND EMBODIMENT

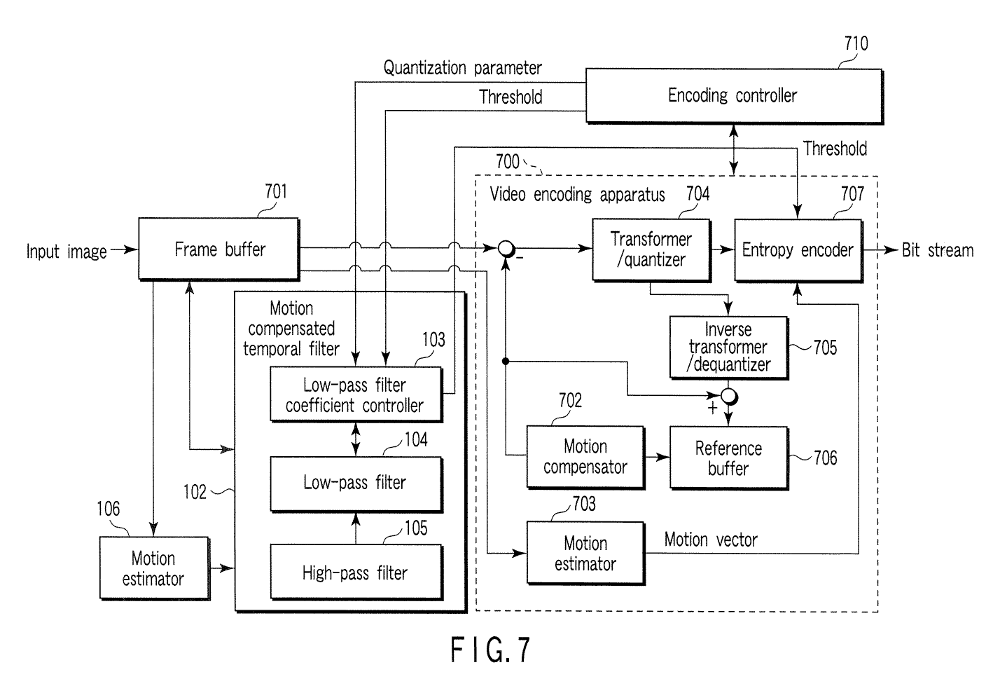

In the second embodiment shown in FIG. 7, a temporal low-pass filter for motion compensated temporal filtering is configured to execute filtering as preprocessing of a conventional video encoding system (H.264/AVC, for example).

A motion compensated temporal filter 102, a low-pass filter coefficient controller 103, a low-pass filter 104, a high-pass filter 105 and a motion estimator 106 are similar to those of the first embodiment. Because the process of the low-pass filter coefficient controller 103 and low-pass filter unit 104 are similar to that shown by the flowchart of FIG. 2, detail description is omitted.

A frame buffer 701 acquires a frame for 1 GOP to be encoded from an input video image or a low-pass frame generated with the motion compensated temporal filter 102. A video encoding apparatus 700 encodes a frame for 1 GOP acquired from a frame buffer 701 and subjected to temporal direction low-pass filtering.

A motion compensator 702 performs motion compensation using frames stored in a reference frame buffer 706 (described hereinafter) according to a motion vector generated with a motion estimator 703. The motion estimator 703 executes motion estimation with respective to the frame stored to frame buffer 701 to detect a motion vector.

A transformer/quantizer 704 subjects the prediction error signal to transform (e.g. discrete cosine transform), and quantizes a transform coefficient based on a quantization parameter determined with an encoding controller 710 and output the quantized transform coefficients to an entropy encoder 707.

An inverse transformer/dequantizer 705 inverse-transforms and dequantizes the prediction error signal transformed and quantized with the transformer/quantizer 704. The reference frame buffer 706 stores as a reference frame the frame reconstructed on the basis of the dequantized and inverse-transformed prediction error signal.

The entropy encoder 707 encodes information such as the quantized coefficient acquired from the transformer/quantizer 704, and the motion vector, prediction mode, quantization parameter and threshold value, which are generated with the motion estimator 703, and multiplexes them with a bit stream. The information multiplexed with the bit stream needs not be always entropy-coded.

The video encoding apparatus 700 subjects the frame preprocessed with a temporal low-pass filter for motion compensated temporal filtering described in the first embodiment to conventional video encoding including a process of producing a local decoded image as in the video image encoding apparatus such as MPEG-2, and H.264/AVC. The video encoding apparatus 700 multiplexes the threshold value determining a high band stopping characteristic of the low-pass filter used for motion compensated temporal filtering with the bit stream, and transmits it. The quantization parameter used with the motion compensated temporal filter 102 may use a quantization parameter determined by prediction. The encoding controller 710 controls the whole of the video encoding apparatus 700.

According to the video encoding apparatus concerning the second embodiment, it is possible to improve the encoding efficiency in comparison with the conventional encoding system and control a high band stopping characteristic of the temporal low-pass filter flexibly, by subjecting the frame filtered with the temporal low-pass filter to conventional video encoding. By multiplexing the threshold value determining a high band stopping characteristic of a low-pass filter with the bit stream, it is possible to use the threshold value for the video decoding apparatus of the fourth embodiment to be described below.

### THIRD EMBODIMENT

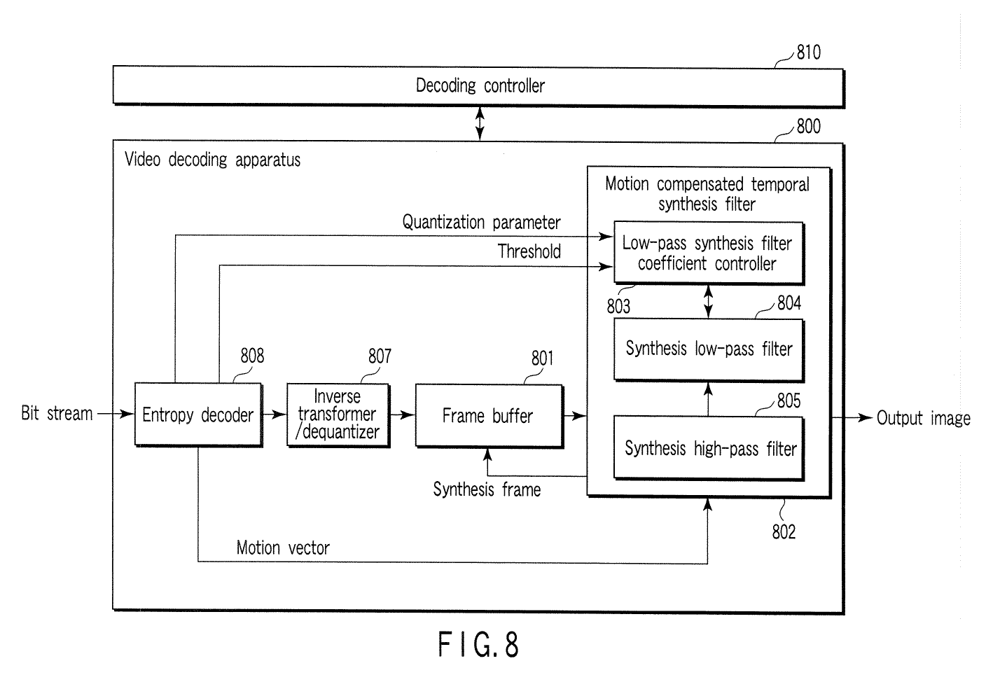

The video decoding apparatus 800 shown in FIG. 8 comprises a frame buffer 801, a motion compensated temporal synthesis filter unit 802, a low-pass synthesis filter coefficient controller 803, a low-pass synthesis filter 804, a high-pass synthesis filter 805, an inverse transformer/dequantizer 807, and an entropy decoder 808, and is controlled with the decoding controller 810.

The entropy decoder 808 decodes information such as a quantized transform coefficient, a motion vector, a prediction mode, a quantization parameter, a threshold value, which are acquired from the bit stream. The inverse transformer/dequantizer 807 dequantizes the quantized transform coefficient based on the quantization parameter acquired from the entropy decoder 808 and inverse-transforms the generated transform coefficient to reconstruct the high-pass frame and low-pass frame (including a quantization error).

The frame buffer 801 acquires the high-pass frame and low-pass frame for 1 GOP from the inverse transformer/dequantizer 807. When performing a composite process using the low-pass frame generated with the motion compensated temporal synthesis filter 802, this frame buffer 801 acquires a low-pass frame from the motion compensated temporal synthesis filter 802.

The motion compensated temporal synthesis filter 802 comprises the low-pass filter coefficient controller 803, the low-pass filter unit 804 and the high-pass filter unit 805. The motion compensated temporal synthesis filter 802 performs the temporal subband composition on the frame acquired from the frame buffer 801 using the motion vector acquired from the entropy decoder 808 and composites the high-pass frame and low-pass frame. The composite frame is output as an output image as-is or sent to the frame buffer 801 to filter it with the motion compensated temporal synthesis filter again. In the case that, for example, a Haar filter is used as the temporal direction filter, a concrete composite process performs the temporal synthesis filtering according to the following equations (9) and (10) obtained by modifying the equations (3) and (4).
A′(x,y)=l′(x,y)−W×ĥ′(x,y) (9)
B′(x,y)=h′(x,y)+1.0×\hat{A′}(x,y) (10)

The synthesis low-pass filter coefficient controller 803 acquires a quantization parameter decoded with the entropy decoder 808 or a threshold value reproduced every plural frames/fields or every frame/field, and controls a characteristic of the synthesis low-pass filter based on them.

The synthesis low-pass filter 804 detects an inverse motion vector for subjecting the acquired frame to the synthesis low-pass filter, performs motion compensation, and carries out the composite process according to, for example, the equation (9), using the synthesis low-pass filter coefficient determined with the synthesis low-pass filter coefficient controller 803.

The synthesis high-pass filter 805 performs motion compensation on the frame acquired from the frame buffer 801 using the motion vector acquired from the entropy decoder 808, and carries out the composite process according to, for example, the equation (10), using a given synthesis high-pass filter coefficient.

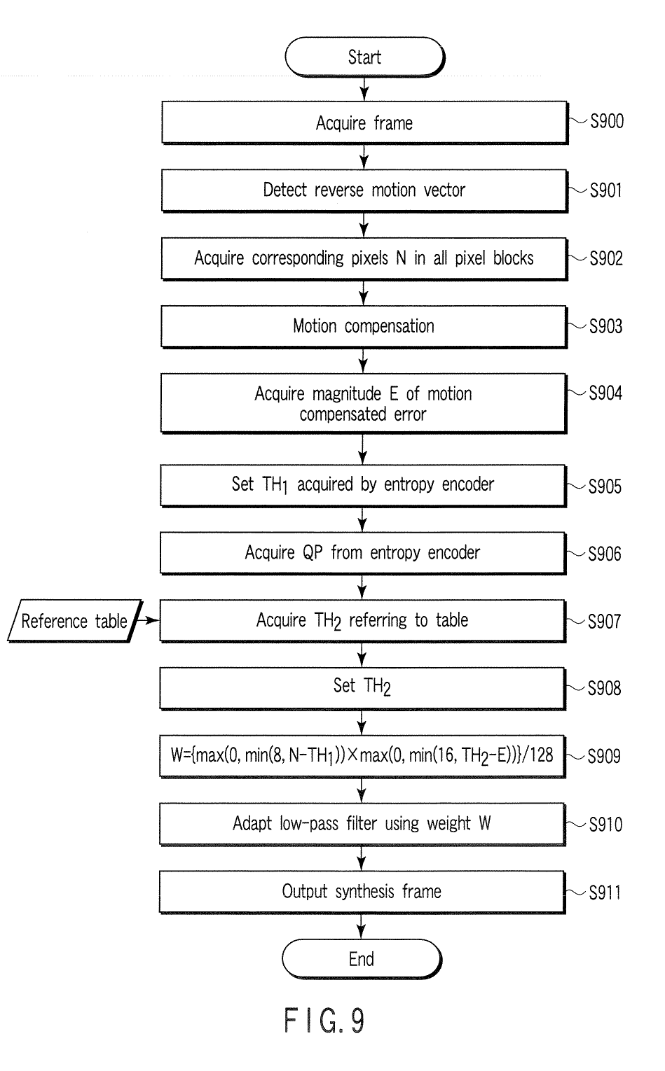

In the video decoding apparatus 800, a process carried out with the synthesis low-pass filter coefficient controller 803 and synthesis low-pass filter 804 concerning the present embodiment will be explained referring to a flow chart of FIG. 9. This flow chart shows a process of determining the weight W concerning the synthesis low-pass filter coefficient, and applying a temporal synthesis low-pass filter according to the weight W. The weight W is calculated by the equation (6) like the encoding apparatus.

When the bit stream including the low-pass frame 1 ′ applied to the synthesis low-pass filter and the high-pass frame h′ to be referred to is input to the video encoding apparatus 800, the filtering process is started (step S900). Thereafter, the code of the motion vector acquired by the entropy decoder 808 is inversed and assigned to each block of the low-pass frame 1′, whereby the inverse motion vector for the synthesis low-pass filter is acquired (step S901). The number N of corresponding pixels is detected every block of the frame 1′ based on the inverse motion vector acquired in the step S901 (step S902).

Motion compensation is performed on the high-pass frame h′ using the inverse motion vector (step S903). Thereafter, the magnitude E of motion compensated error in the motion compensated high-pass frame h′ corresponding to each block of the frame 1′ is calculated based on the equation (7) (step S904). The threshold value TH1 about the number of corresponding pixels N is acquired from the entropy decoder 808 and set to the inverse-transformer/dequantizer 807 (step S905).

The threshold value TH1 is defined by the syntax structure of FIGS. 4 to 6 like the encoding apparatus, and is provided every plural frames/fields or every frame/field. When the threshold value TH1 is not given, 8 may be set similarly to the conventional technique.

The quantization parameter QP is acquired from the entropy decoder 808 (step S906). Subsequently, the threshold value TH2 about E is acquired referring to a predetermined table (step S907). The acquired TH2 is set to the equation (6) (step S908). A table similar to the table of the encoding apparatus will be prepared in the decoding apparatus beforehand.

The weight W given to the synthesis low-pass filter coefficient is calculated according to the equation (6) determined by the threshold values TH1 and TH2 set in steps S905 and S908 (step S909). After the weight W is obtained for all blocks of the frame 1′ in this step S909, the synthesis low-pass filter is applied to the frame using the weight W (step S910) and a composite output image or low-pass frame is output (step S911).

In this way, according to the video decoding apparatus concerning the third embodiment, the decoding apparatus can realize an adaptive synthesis low-pass filter every coarseness of quantization or every plural frames/fields or every frame/field, based on the high band stopping characteristic of the temporal low-pass filter determined in the encoding apparatus.

### FOURTH EMBODIMENT

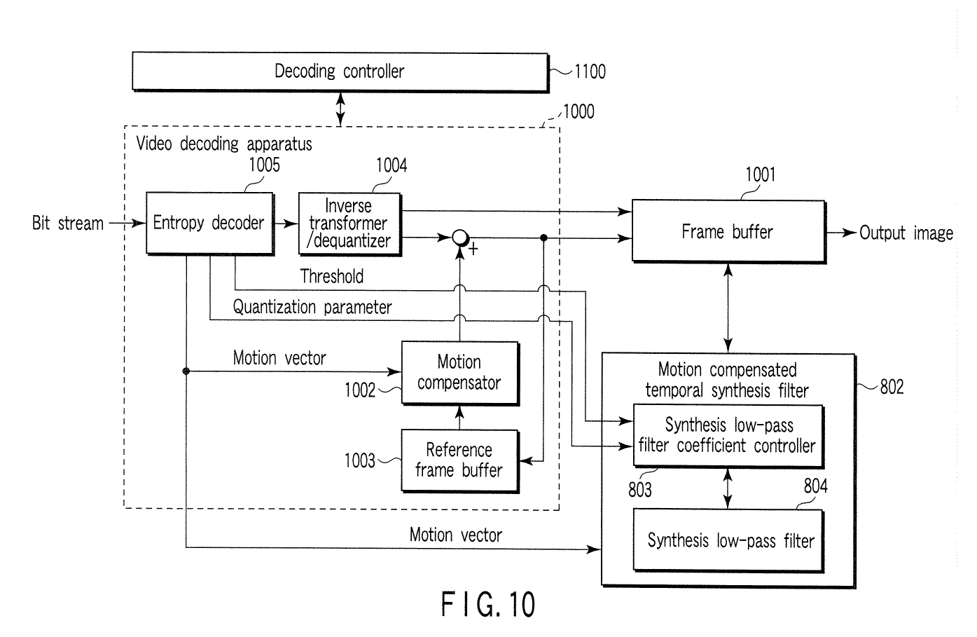

In the fourth embodiment shown in FIG. 10, the temporal synthesis low-pass filter of motion compensated temporal synthesis filtering in the third embodiment is carried out as post-processing of a conventional video decoding system.

A video decoding apparatus 1000 decodes a received bit stream according to a conventional decoding method such as H.264/AVC, and outputs the decoded image to the frame buffer 1001. The entropy decoder 1005 decodes information such as quantized transform coefficient, a motion vector, a prediction mode, a quantization parameter, and a threshold value, which are acquired from the bit stream.

An inverse transformer/dequantizer 1004 dequantizes the quantized transform coefficient based on a quantization parameter acquired from the entropy decoder 1005, and inverse-transforms the generated transform coefficient to reconstruct a prediction error signal (including a quantization error).

A motion compensator 1002 performs motion compensation on the frame stored in a reference frame buffer 1003 according to a motion vector acquired from an entropy decoder 1005. The reference frame buffer 1003 stores the reference frame reproduced based on the prediction error signal obtained by inverse transform/dequantization. A decoding controller 1100 controls the whole of the video decoding apparatus 1000.

The frame buffer 1001 acquires a decoded frame for 1 GOP output with the video decoding apparatus 1000, a prediction error signal generated with the inverse transformer/dequantizer 1004 or a frame generated with the motion compensated temporal synthesis filter 802.

The motion compensated temporal synthesis filter 802 subjects the decoded image and prediction error signal acquired from frame buffer 1001 to the synthesis low-pass filtering using the motion vector information acquired from the entropy decoder 1005.

The synthesis low-pass filter coefficient controller 803 and synthesis low-pass filter 804 are similar to those of the third embodiment, and the process of the synthesis low-pass filter coefficient controller 803 and the synthesis low-pass filter 804 is similar to that shown in the flow chart of FIG. 9. Therefore, any further explanation is omitted.

According to the video decoding apparatus concerning the fourth embodiment, the synthesis low-pass filter for motion compensated temporal synthesis filtering shown in the third embodiment can be applied to the frame reconstructed by the conventional video image decoding technique as post-processing. The video image encoded in the second embodiment can be subjected to the temporal synthesis low-pass filtering as a post-processing process based on the high band stopping characteristic of the low-pass filter of the encoding apparatus by acquiring low-pass filter coefficient control information.

According to the present invention, the encoding efficiency improves by controlling the high band stopping characteristic of a low-pass filter based on coarseness of quantization. The encoding efficiency improves by controlling adaptively the threshold value in the low-pass filter coefficient control function with plural images or a single image.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video encoding method comprising:
subjecting an input video image to motion compensated temporal filtering using a motion compensated temporal filter including a low-pass filter to produce a low-pass filtered image;
quantizing a transform coefficient of the low-pass filtered image using a quantization parameter;
encoding a quantized transform coefficient;
calculating a weight to be given to a low-pass filter coefficient of the low-pass filter according to the quantization parameter and a magnitude of a motion compensated error occurring due to motion compensation in the motion compensated temporal filtering; and
controlling a high band stopping characteristic of the low-pass filter according to the low-pass filter coefficient weighted by the weight,
wherein the controlling controls the high band stopping characteristic of the low-pass filter to provide a positive correlation with respect to the quantization parameter and provide a negative correlation with respect to the magnitude of the motion compensated error.

2. The method according to claim 1, wherein the controlling includes determining the low-pass filter coefficient based on the magnitude of the motion compensated error and a threshold value selected according to a predetermined table based on the quantization parameter by referring to the table to control the high band stopping characteristic of the low-pass filter.

3. The method according to claim 1, wherein the motion compensated temporal filtering includes dividing hierarchically the image into a plurality of frames using the motion compensated temporal filter.

4. The method according to claim 1, wherein the motion compensated temporal filter uses a Haar filter.

5. The method according to claim 1, wherein the motion compensated temporal filtering includes performing a filter process by a lifting operation using a high-pass filter and the low-pass filter step by step.

6. A video encoding method comprising:
performing motion compensated temporal filtering on an input video image with a motion compensated temporal filter including a low-pass filter to produce a low-pass filtered image;
detecting a magnitude of the motion compensated error occurring due to motion compensation in the motion compensated temporal filtering;
detecting a motion vector for motion compensation in the motion compensated temporal filtering;
selecting a threshold value every plural images or every image;
calculating a low-pass filter coefficient of the low-pass filter based on a magnitude of the motion compensated error, the motion vector and the threshold value;
controlling a high stopping characteristic of the low-pass filter according to the low-pass filter coefficient;
encoding the threshold value; and
multiplexing the encoded threshold value with a bit stream.

7. A video decoding method comprising:
decoding a received bit stream to generate a decoded image, a quantization parameter and a threshold value for determining a high band stopping characteristic;
subjecting the decoded image to motion compensated temporal synthesis filtering using a motion compensated temporal synthesis filter including a synthesis low-pass filter to generate a synthesis low-pass filtered image;
controlling a high band stopping characteristic of the synthesis low-pass filter according to the high band stopping characteristic parameter; and
acquiring a motion compensated error from the received bit stream,
wherein the controlling controls the high band stopping characteristic of the low-pass filter to provide a positive correlation with respect to the quantization parameter and a negative correlation with respect to a magnitude of the motion compensated error.

8. The method according to claim 7, wherein the controlling includes calculating a synthesis low-pass filter coefficient based on the magnitude of the motion compensated error and the threshold value selected according to a predetermined table based on a quantization parameter by referring to the table to control a high band stopping characteristic of the low-pass filter.

9. A video decoding method comprising:
decoding a received bit stream to generate a decoded image, a quantization parameter, a motion vector and a threshold value for determining a high band stopping characteristic;
subjecting the decoded image to motion compensated temporal synthesis filtering using a motion compensated temporal synthesis filter including a synthesis low-pass filter to generate a synthesis low-pass filtered image;
controlling a high band stopping characteristic of the synthesis low-pass filter according to the threshold value; and
acquiring a motion compensated error from the receiving bit stream,
wherein the controlling includes controlling the high band stopping characteristic of the synthesis low-pass filter based on the motion compensated error, the threshold value and the motion vector.

10. A video encoding apparatus of encoding an image, comprising:
a motion compensated temporal filter including a low-pass filter to subject a video image to motion compensated temporal filtering to produce a low-pass filtered image;
a quantizer to quantize a transform coefficient of the low-pass filtered image;
an encoder to encode a quantized transform coefficient,
a calculator to calculate a weight given to the low-pass filter coefficient according to a quantization parameter representing coarseness of quantization and a magnitude of a motion compensated error occurring due to motion compensation in the motion compensated temporal filtering; and
a controller to control a high band stopping characteristic of the low-pass filter according to a low-pass filter coefficient of the low-pass filter weighted by the weight,
wherein the controller controls the high band stopping characteristic of the low-pass filter to provide a positive correlation with respect to the quantization parameter and a negative correlation with respect to the magnitude of the motion compensated error.

11. The apparatus according to claim 10, wherein the controller includes a table used for determining a threshold value and a determining unit configured to determine the low-pass filter coefficient based on the magnitude of the motion compensated error and a threshold value selected according to the table based on the quantization parameter by referring to the table to control the high band stopping characteristic of the low-pass filter.

12. The apparatus according to claim 10, wherein the motion compensated temporal filter includes a dividing unit configured to divide hierarchically the video image into a plurality of frames.

13. The apparatus according to claim 10, wherein the motion compensated temporal filter uses a Haar filter.

14. The apparatus according to claim 10, wherein the motion compensated temporal filter includes a filter of performing a filter process by a lifting operation using a high-pass filter and the low-pass filter step by step.

15. A video encoding apparatus of encoding an image, comprising:
a motion compensated temporal filter including a low-pass filter to subject a video image to motion compensated temporal filtering to generate a low-pass filtered image;
an error detector to detect a magnitude of a motion compensated error occurring due to motion compensation in the motion compensated temporal filtering;
a motion vector detector to detect a motion vector for motion compensation;
a threshold value generator to generate a threshold value;
a selector to select dynamically the threshold value every plural images or every image;
a calculator to calculate a low-pass filter coefficient of the low-pass filter based on the magnitude of the motion compensated error, the motion vector and the threshold value;
a controller to control a high band stopping characteristic of the low-pass filter according to the low-pass filter coefficient;
an encoder to encode the threshold value; and
a multiplexer to multiplex the encoded threshold value with a bit stream,

16. A video decoding apparatus of decoding an image of a received bit stream, comprising:
a motion compensated temporal synthesis filter including a synthesis low-pass filter to subject an image to motion compensated temporal synthesis filtering to generate a synthesis low-pass filtered image;
a controller to control a high band stopping characteristic of the synthesis low-pass filter;
a quantization parameter detector to detect a quantization parameter from the received bit stream; and
an error detector to detect a motion compensated error from the received bit stream, wherein
the controller controls the high band stopping characteristic of the low-pass filter to provide a positive correlation with respect to the quantization parameter and a negative correlation with respect to the magnitude of the motion compensated error.

17. The apparatus according to claim 16, wherein the motion compensated temporal synthesis filter includes a composite unit configured to composite a plurality of frames of the decoded image, which are divided hierarchically.

18. The apparatus according to claim 16, wherein the motion compensated temporal synthesis filter uses a Haar filter.

19. The apparatus according to claim 16, wherein the motion compensated temporal synthesis filter includes a filter to perform a filter process by a lifting operation using a high-pass filter and the low-pass filter step by step.

20. A video decoding apparatus of decoding an image of a received bit stream, comprising:
a decoder to decode a received bit stream to generate a decoded image, a quantization parameter and a threshold value for determining a high band stopping characteristic;
a motion compensated temporal synthesis filter including a synthesis low-pass filter to subject the decoded image to motion compensated temporal synthesis filtering to generate a synthesis low-pass filtered image;
a controller to control a high band stopping characteristic of the synthesis low-pass filter; and
an error detector to detect a motion compensated error from the received bit stream, wherein
the controller controls a high band stopping characteristic of the synthesis low-pass filter based on a magnitude of the motion compensated error, the motion vector and the threshold value.
